(19) United States
(12) Patent Application Publication
(10) Pub. No.: US 2005/0017648 A1
(43) Pub. Date: Jan. 27, 2005

(54) Display device

(76) Inventors: Ron Naaman, Rehovot (IL); Erez Halahmi, Bazra (IL)

Correspondence Address: NATH & ASSOCIATES, PLLC, Sixth Floor, 1030 15th Street, N.W., Washington, DC, 20005, US

(21) Appl. No.: 10/895,994

(22) Filed: Jul. 22, 2004

Related U.S. Application Data
(60) Provisional application No. 60/488,797, filed on Jul. 22, 2003.
(60) Provisional application No. 60/517,387, filed on Nov. 6, 2003.

(51) Int. Cl. G09G 3/10

(52) U.S. Cl. 315/169.1; 315/169.4

(57) ABSTRACT

A display device is presented. The display device includes an electrodes' arrangement and an electrons' extractor. The electrodes' arrangement comprises a Cathode electrode layer having at least one Cathode electrode and an Anode electrode layer having at least one Anode electrode, the Cathode and Anode electrode layers being accommodated in a spaced-apart relationship with a gap between them. The Anode layer carries a luminescent screen assembly on its surface. The electrodes arrangement is operable to create a desired electrical field between the electrodes. The electrons' extractor operates to extract electrons from at least a selected region of the Cathode electrode layer by illuminating this Cathode region with exciting illumination of a predetermined wavelength range to cause the electron emission from the illuminated Cathode region.

### FIELD OF THE INVENTION

This invention relates to display devices, particularly flat panel displays.

### BACKGROUND OF THE INVENTION

Generally, known techniques used in flat panel displays can be divided as relating to the following three groups—liquid crystal displays (LCDs), plasma display panels (PDPs), and CRT displays.

An LCD is based on the property of rod-like molecules of a liquid crystal to be reorientable in space in response to an electric field applied across the LC layer and thus affect the light propagation through the LC layer. An LCD may be of a transmissive or reflective technology.

PDP works on the principle that passing a high voltage through a low-pressure gas generates light. Essentially, a PDP can be viewed as a matrix of tiny fluorescent tubes which are controlled in a sophisticated fashion. Each pixel, or cell, comprises a small capacitor with three electrodes. An electrical discharge across the electrodes causes the rare gases sealed in the cell to be converted to plasma form as it ionises. Plasma is an electrically neutral, highly ionised substance consisting of electrons, ions, and neutral particles. Being electrically neutral, it contains equal quantities of electrons and ions and is, by definition, a good conductor. Once energized, the cells of plasma release ultraviolet (UV) light which then strikes and excites red, green and blue phosphors along the face of each pixel, causing them to glow. PDPs are like CRTs in that they are emissive and use phosphor, and like LCDs in their use of an X and Y grid of electrodes separated by an MgO dielectric layer and surrounded by a mixture of inert gases—such as argon, neon or xenon—to address individual picture elements.

CRT based displays utilize the principles of vacuum microelectronics (based on ballistic movement of electrons in vacuum), and employ electron emission devices or field emission devices. Flat panel displays utilizing a field emission Cathode are disclosed for example in U.S. Pat. Nos. 4,577,133; 4,857,799; 5,543,684; 5,551,903; 6,580,223, as well as in EP0476975.

Modern electronic devices provide an increasing amount of functionality with a decreasing size. An example of such development is the provision of a touch screen in conjunction with a variety of display types, including CRTs and LCD screens, as a means of inputting information into a data processing system. When placed over a display or integrated into a display, the touch screen allows a user to select a displayed icon or element by touching the screen in a location corresponding to the desired icon or element. Touch screens have become common place in a variety of different applications including, for example, point-of-sale systems, information kiosks, automated teller machines (i.e., ATMs), data entry systems, etc. Various touch screens, including those associated with CRT, are described for example in U.S. Pat. No. 6,504,530.

### SUMMARY OF THE INVENTION

There is a need in the art to improve operation of emissive displays by enabling increase in the life time of the device and simplifying the device manufacture, as compared to the conventional field emission based display devices.

The display device of the present invention typically utilizes an electrodes' arrangement, formed by at least one Cathode electrode and at least one Anode electrode, and possibly also at least one Gate electrode. The main idea of the present invention consists of using electromagnetic radiation as means for extracting electrons from the Cathode. In other words, an electron emission device of the present invention is operable by the photoelectric effect, according to which photons are used for ejecting electrons from a material of the Cathode, provided the photon energy exceeds the work-function of the material from which the Cathode is made.

According to one broad aspect of the present invention, there is provided a display device comprising:
an electrodes' arrangement including a Cathode electrode layer having at least one Cathode electrode and an Anode electrode layer having at least one Anode electrode, the Cathode and Anode electrode layers being accommodated in a spaced-apart relationship with a gap between them, the Anode electrode layer carrying a luminescent screen assembly on its surface, the electrodes arrangement being operable to create a desired electrical field between the electrodes;
an electrons' extractor for extracting electrons from at least a selected region of the Cathode electrode layer by illuminating said at least selected region of the Cathode electrode layer with exciting illumination of a predetermined wavelength range to cause the electron emission from the illuminated Cathode region.

The luminescent screen assembly (e.g., coating) may be located on either the outer or inner surface of the Anode electrode layer. In the latter case, the Anode electrode is partially or completely transparent.

Generally, the entire structure formed by the Anode with the luminescent screen thereon may be at least partially transparent. This may for example be used to implement a touch screen function in the display device; or to enable electrons extraction from the Cathode by external illumination coming from the outside of the electrodes arrangement via the Anode with luminescent coating.

At least one of the Cathode and Anode electrode layers may be formed by an array of spaced-apart electrode-elements, defining an image pixel array of the display device.

The electrodes' arrangement may comprise an additional, Gate electrode layer. The Gate electrode may be accommodated between the Cathode and Anode electrode layers (e.g., in a plane parallel thereto). The Gate electrode layer may be in the form of a grid allowing material propagation therethrough, or may be in the form of a patterned layer defining an array of spaced-apart Gate electrode-elements in accordance with the pixel array of the device.

One of the electrode layers may be patterned to define a first array of electrodes extending along a first axis, and another one of the electrode layers may be patterned to define a second array of electrodes extending along a second axis perpendicular to the first axis. These first and second arrays define together a two-dimensional pixel array of the device (rows and columns).

It should be noted that the term “patterned” or “pixel-patterned” used herein with respect to an electrode layer signifies a layer in the form of an array of spaced-apart electrode-elements arranged in accordance with an image pixel array of the display device, namely defining the entire two-dimensional pixel array or defining a one-dimensional array so as to define, together with another patterned layer, a two-dimensional pixel array.

In general, the electrical field between the Cathode and Anode (and therefore the current in-between) depends on a distance between them, the dielectric coefficient of a material in the gap between them, etc.

Actuation of a selective pixel of the display device may be implemented by several operational modes of the device.

In one embodiment of the invention, the above is achieved by controllably varying an electric field between a selected electrode-element of the Cathode and the Anode layer (or a selected pair of vertically aligned Cathode and Anode elements in the case both of these layers are patterned). In this case, a certain value or controllably varying value of the exciting illumination is applied to the entire Cathode layer surface. The Gate electrode in the form of a grid may be used between the Cathode and Anode layers. In this case, actuation of a selected image pixel is implemented by varying a voltage supply to the Gate thus selectively applying a potential difference between the Gate electrode layer and a selected electrode-element of the Cathode and Anode layer (or a selected pair of vertically aligned Cathode and Anode elements). If the Gate electrode layer is patterned to define image pixel array, while each of the Cathode and Anode layers may and may not be correspondingly patterned, then the selective image pixel is actuated by selectively applying voltage to the selected Gate electrode-element, thus selectively applying a potential difference between the corresponding (aligned) Cathode and Gate regions. If there is no Gate layer in the electrodes' arrangement, then a selective image pixel is actuated by applying a change in the potential difference between a selected pair of the Cathode and Anode layers' regions (aligned regions) as compared to the potential difference between the Cathode and Anode layers outside these selected pair of regions.

In all the above implementations, the illumination may and may not be controllably varied. The illumination of the entire Cathode layer may be “internal” to the electrodes' arrangement, the illuminator being configured so as to directly illuminate only the Cathode layer, or to illuminate the inner surfaces of both the Cathode and Anode layers, by which they face each other. In the latter case, the Cathode electrode layer becomes illuminated both directly and by reflection of light from the Anode layer. Alternatively, as indicated above, such illumination may be “external” to the electrodes' arrangement. In this case, a structure formed by the Anode electrode layer with the luminescent screen thereon may be optically transparent (partially or completely) to thereby illuminate the Cathode through this structure; or the Cathode (as well as a substrate carrying the Cathode, as the case may be) may be semitransparent to thereby illuminate the Cathode surface from “below”.

It should be understood that the separate voltage supply to the electrode arrangement defining a pixel may be achieved by any suitable conventional technique, for example by dividing the electrodes array into rows and columns, as described above.

In another embodiment of the invention, the selective pixel actuation is achieved by controlling an electric current between the selective pair of Cathode and Anode electrode layers' regions (presenting an image pixel) by means of controlling the light intensity causing electrons' extraction from this selective Cathode region. The illuminating assembly in this case presents the so-called “floating gate”. This is implemented by providing the illuminating assembly in the form of an array of light units, presenting an image pixel array, arranged in a spaced-apart relationship such that each light unit is associated (illuminates) a corresponding region of the Cathode-electrode layer. The light unit may be a light emitting element itself, or a light guiding unit for directing light from a light emitting element to a corresponding region of the Cathode. The light intensity may be modified by appropriately operating a light emitting element or affecting light while propagating from the light emitting element (e.g., affecting polarization or phase of light).

In this second embodiment, means are preferably provided to prevent a change of light intensity actuating the selected pixel from affecting a change in an electric current of a locally adjacent pixel. This can be achieved by using an optical mask located proximate the light units. The mask may be in the form of an array of projections spaced from each other, with the light units being located within these spaces, respectively. Alternatively, in order to prevent undesirable illumination of Cathode regions outside the selected region, the Cathode layer may be in the form of an array of tip-like electrode-elements and each of the light units is located proximate to the corresponding one of the tip-like elements. This results in that light in a region of the closest vicinity of the tip-electrode affects electric current therein much higher than light from the other, spaced regions.

In yet another implementation of the second embodiment of the invention, modifying the illumination of a selected Cathode region is achieved by using at least one light emitter associated with a controllable light deflection system. The latter is operable to selectively direct the emitted light beam towards a desired region of the Cathode.

The luminescent screen assembly may be located on the outer surface of the Anode electrode, or on the inner surface thereof, and a structure formed by the Anode with luminescent screen may be at least partially optically transparent, for example by patterning the luminescent coating and using transparent Anode layer or by patterning the entire structure. When using the transparent (or partially transparent) structure of Anode with luminescent coating, external illumination can be used as electrons' extractor from the Cathode electrode.

The principles of the present invention (the use of Cathode illumination for extracting electrons therefrom) can be used for creating an interactive screen function of the display device, namely a touch screen function or a remote pointing. This is based on effecting, by touching/pointing, a change in an electric current between the Anode and Cathode electrodes' regions aligned with the touched/pointed location, as compared to other Cathode and Anode regions. The mechanism for causing a change in the current can for example be implemented by one of the following ways:
(1) A change in the illumination intensity causes a change in the photoelectrons current between the Cathode and Anode.
(2) A change in a distance between the Anode and the Cathode causes a change in an electric field (as it is linearly dependent on the distance between Cathode and Anode) and therefore effects a change in the current between the Cathode and Anode.

Each of the above two options may be implemented by making the structure, formed by the Anode layer with the luminescent screen assembly thereon, sufficiently flexible such that touching an external surface of this structure causes a local deformation within the touched location, thereby enabling identification of the touched location. The first option may also be implemented by using a remote (external) light pointer and at least partially transparent structure of the Anode electrode with luminescent coating.

According to another broad aspect of the invention, there is provided a display device comprising
an electrodes' arrangement including a Cathode electrode layer having at least one Cathode electrode and an Anode electrode layer having at least one Anode electrode, the Cathode and Anode electrode layers being accommodated in a spaced-apart relationship with a gap between them, and a Gate electrode layer in the form of a grid located between the Cathode and Anode layers, the Anode layer carrying a luminescent screen structure on its surface, at least one of the Cathode and Anode electrode layers being formed by an array of spaced-apart electrode-elements defining an image pixel array of the display device,
an electrons' extractor configured and operable to produce exciting radiation to illuminate at least a selected region of the Cathode electrode layer to extract electrons from the illuminated Cathode electrode;
a control unit for operating the electrodes' arrangement by supplying voltages to the electrodes, and operating the electrons' extractor to illuminate the Cathode electrode;
   the device being operable to actuate a selective image pixel by carrying out at least one of the following: varying the voltage supply to the Gate, and modifying the illumination reaching the Cathode layer.

According to yet another aspect of the invention, there is provided a display device comprising:
an electrodes' arrangement including a Cathode electrode layer having at least one Cathode electrode and an Anode electrode layer having at least one Anode electrode, the Cathode and Anode layers being accommodated in a spaced-apart relationship with a gap between them, the Anode layer carrying a luminescent screen assembly on its surface, a structure formed by the Anode layer with the luminescent screen assembly thereon being at least partially optically transparent; and
an electrons' extractor configured and operable to produce exciting radiation to extract electrons from the Cathode electrode by illuminating at least a selective region of the Cathode electrode layer by the exciting radiation propagating to the Cathode through the Anode electrode layer.

According to yet another aspect of the invention, there is provided a display device comprising:
an electrodes' arrangement including a Cathode electrode layer having at least one Cathode electrode and an Anode electrode layer having at least one Anode electrode, the Cathode and Anode layers being spaced by a gap, the Anode layer carrying a luminescent screen assembly on its surface;
an electrons' extractor operable to produce exciting radiation to extract electrons from the Cathode, the electrons' extractor comprising an array of light units arranged in accordance with an image pixel array, the light units being accommodated such that each of the light units illuminates a corresponding region of the Cathode electrode layer and thus extracts electrons therefrom.

According to yet another aspect of the invention, there is provided a display device comprising:
an electrodes' arrangement including a Cathode electrode layer having at least one Cathode electrode and an Anode electrode layer having at least one Anode electrode, the Cathode and Anode layers being accommodated in a spaced-apart relationship with a gap between them, the Anode layer carrying a luminescent screen assembly on its surface, the Cathode electrode layer being made of a material at least partially transparent with respect to a spectral range of exciting radiation;
an electrons' extractor configured to produce the exciting radiation to extract electrons from the Cathode, the electrons' extractor comprising an array of light units arranged in a spaced-apart relationship in accordance with an image pixel array, the light units being accommodated outside the electrodes' arrangement, each of the light units being separately operated to illuminate a corresponding region of the inner surface of the Cathode electrode layer through the Cathode layer to thereby extract electrons from the illuminated Cathode region towards the Anode layer.

According to yet another aspect of the invention, there is provided a display device configured to define an array of image pixels, the device comprising an electrodes' arrangement, and an illuminator assembly configured and operable to produce exciting illumination to extract electrons from a Cathode electrode.

According to yet another aspect of the invention, there is provided a display device comprising an electron emission device comprising an electrodes' arrangement including at least one Cathode electrode and at least one Anode electrode, the Cathode and Anode electrodes being arranged in a spaced-apart relationship; the electron emission device being configured to expose said at least one Cathode electrode to exciting illumination to thereby cause electrons' emission from said Cathode electrode.

According to yet another aspect of the invention, there is provided a display device comprising an electron emission device comprising an electrodes' arrangement including at least one Cathode electrode, at least one Anode electrode, and at least one Gate electrode, the electrodes being arranged in a spaced-apart relationship; the electron emission device being configured to expose said at least one Cathode electrode to exciting illumination to thereby cause electrons' emission from said Cathode electrode.

According to yet another aspect of the invention, there is provided a display device configured to define an array of image pixels, the device comprising an electrodes' arrangement, and an illuminator assembly producing exciting radiation to extract electrons from a Cathode electrode, the illuminator assembly being configured and operable to illuminate a surface of the Cathode electrode, by which it faces an Anode electrode, through the Cathode electrode made of a material at least partially transparent with respect to the exciting illumination.

The present invention in yet another aspect provides a method for operating a display device which includes a Cathode electrode layer and an Anode electrode layer, the method comprising illuminating at least a selected region of the Cathode electrode layer with exciting radiation to extract electrons from the at least one illuminated Cathode region, thereby affecting an electric current between said at least one selected region of the Cathode electrode and an Anode electrode layer.

The present invention, according to its yet another aspect, provides an electron emission display device based on a new technology, the so-called “gas-nano-technology”. This technique provides for electrons' passage in air or another gas environment, and thus eliminates or at least significantly reduces the high vacuum requirements of large scale vacuum devices. This is implemented by accommodating Cathode and Anode electrodes with a gap between them substantially not exceeding a mean free path of electrons in the respective gas medium.

There is provided a display device comprising an electrodes' arrangement including a Cathode electrode layer and an Anode electrode layer which are accommodated in spaced-apart parallel planes with a gas-medium gap between them of a length substantially not exceeding a mean free path of electrons in said gas medium, the Anode layer carrying a luminescent screen assembly on its surface.

### BRIEF DESCRIPTION OF THE DRAWINGS

In order to understand the invention and to see how it may be carried out in practice, preferred embodiments will now be described, by way of non-limiting examples only, with reference to the accompanying drawings, in which:

FIG. 1A is a schematic illustration of a flat panel display device according to one embodiment of the invention;

FIG. 1B is a schematic illustration of a display device according to another embodiment of the invention;

FIG. 1C is a schematic illustration of a display device according to yet another embodiment of the invention;

FIG. 2 exemplifies the operation of an electrons extractor assembly in the device of FIG. 1A;

FIG. 3 illustrates a specific example of the implementation of the device of FIG. 1A;

FIGS. 4A and 4B schematically illustrate two examples, respectively, of a flat panel display device according to yet another embodiment of the invention; and

FIGS. 5A to 5E show several examples of the device of the present invention utilizing a touch screen function.

### DETAILED DESCRIPTION OF THE INVENTION

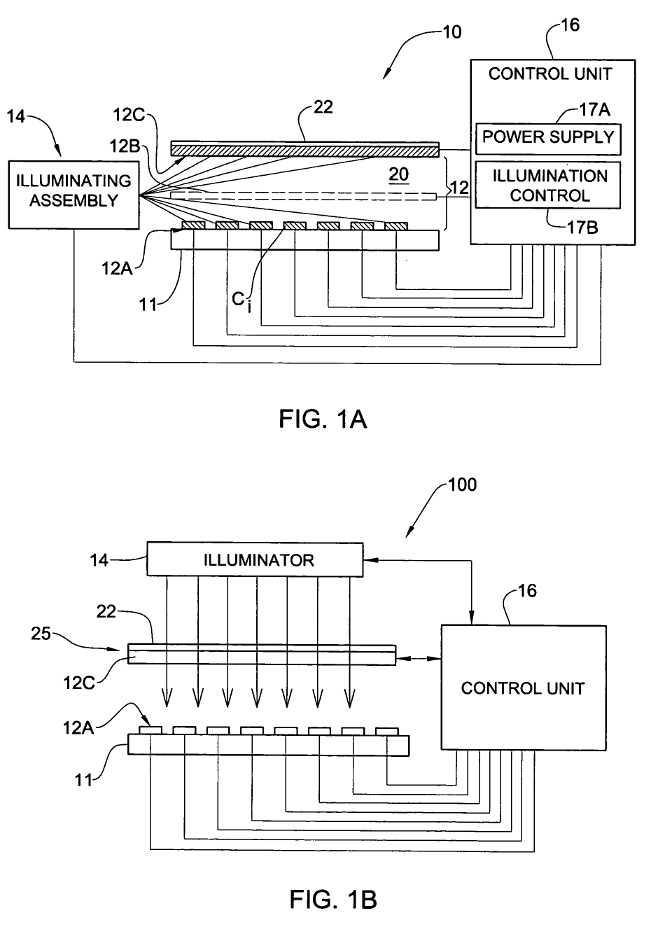

Referring to FIG. 1A, there is illustrated a flat panel display device 10 according to one embodiment of the invention. The display device 10 comprises such main constructional parts as an electrodes' arrangement 12 and an illuminating assembly 14 (constituting an electrons' extractor). The device 10 is operated by a control unit 16 including inter alia a power supply system 17A for operating the electrodes arrangement 12, and an appropriate illumination control utility 17B for operating the electrons extractor 14.

The electrodes' arrangement 12 includes a Cathode electrode layer 12A (including one or more Cathode elements) and an Anode electrode layer 12C (including one or more Anode electrodes) which are arranged in a spaced-apart relationship (e.g., in two spaced-apart parallel planes), and may and may not be of the same dimensions. In the present example, the electrodes' arrangement also includes a Gate electrode layer 12B, which is accommodated between the Cathode and Anode layers 12A and 12C. The Gate electrode layer 12B may be in the form of a grid, or may be patterned to form an array (e.g., two-dimensional array) of spaced-apart Gate electrode-elements in accordance with an image pixel array of the device.

The Anode electrode layer 12C carries a luminescent screen assembly 22 (e.g., phosphor layer) on its surface. Generally, the luminescent screen may be located on either inner or outer surface of the Anode. In the present example, the luminescent screen assembly 22 is located on an outer surface of the Anode layer 12C.

Generally, at least one of the Cathode, Anode and Gate electrode layers may be patterned to define a two-dimensional array of electrode-elements presenting a pixel array of the display device. Alternatively, the configuration may be such that a two-dimensional pixel array is achieved as “rows” and “columns” arrangement of two different electrode layers, respectively. For example, the Cathode layer includes an array of spaced-apart Cathode “strips” extending along one axis, and the Anode layer includes an array of spaced-apart Anode “strips” extending along an axis perpendicular to that of the Cathode strip.

In the present example, the Cathode layer 12A is patterned, namely is formed by an array of spaced-apart Cathode electrode-elements, generally at Cᵢ, for example arranged on top of an electrically insulating substrate 11 (e.g., silicon oxide).

Generally, the electrons' extractor assembly 14 is an illuminator operable in a wavelength range including the exciting illumination for the Cathode, and is configured for illuminating at least a selected region of the Cathode surface by which it faces the Anode. In the present example of FIG. 1A, the electrons extractor 14 is configured for illuminating substantially the entire surface of the Cathode layer. Additionally, in the present example of FIG. 1A, the electrons extractor 14 includes an internal illuminator, namely accommodated within the electrodes' arrangement. The illuminator 14 is oriented with respect to the electrodes' arrangement 12 so as to illuminate at least the Cathode layer 12A, or as shown in the present example, to directly illuminate the inner surfaces of both the Cathode and Anode layers 12A and 12C, and thus the Cathode layer 12A is irradiated by both direct illumination and light reflections from the Anode layer 12C.

It should be understood that the “internal” illumination not necessarily means that a light emitting assembly itself is located inside the electrodes' arrangement. For example, the illuminator may include a light emitting assembly located outside the device, and an optical guiding assembly (e.g., fibers) for connecting the light emitting assembly to the inside of the device. In other words, what is physically brought to an illuminating location with respect to the electrodes' arrangement is a light unit (or more than one light units), wherein the light unit may be a light emitting assembly or a light guiding assembly.

The illuminator 14 may include one or more light emitting elements (e.g., LEDs) and one or more light guiding assemblies. Preferably, an array (generally at least two) light units are used presenting at least two light emitting elements, respectively, or at least two light guiding assemblies associated with at least one light emitter. Such light units are accommodated aside the Cathode and Anode layers within the space between them.

The Anode electrode 12C is spaced from the Cathode electrode 12A by a gap 20, which may be a vacuum gap or a gas-medium gap (e.g., air, inert gas). For example, the Cathode and Anode layers are spaced from each other by the gap of about 3-4 mm, considering vacuum environment inside the display device.

It should be noted that in the case there is a gas in the gap, the gas pressure needs to be low enough, so the mean free path of electrons accelerating from the Cathode to the Anode will be larger than a distance between the Cathode and the Anode layers. For example, for a 10 micron gap between the Cathode layer 12A and a structure 25 formed by the Anode 12C with a luminescent screen 22 thereon, a gas pressure of a few mBar may be used.

The electrodes may be made from metal or semiconductor materials. Preferably, the Cathode electrode has a relatively low work function or a negative electron affinity (NEA), like in diamond, thus reducing the photon energy (exciting energy) necessary to induce photoemission. Another way to reduce the work function is by coating or doping the Cathode electrode 12A with an organic or inorganic material. Thus, the electrodes may be made from appropriate materials and/or an organic or inorganic coating or doping is provided on the Cathode electrode (a coating or doping that creates a dipole layer on the surface which reduces the work function). For example, the Cathode layer 12A may be made from Cs coated metal(s) or semiconductor (e.g., cesium coated GaAs), while the Anode layer 12C may me made from a thin layer of chromium.

The control unit 16 operates illumination of at least the entire surface of the Cathode electrode layer and voltage supply to the Cathode, Anode and Gate electrodes. For example, a desired potential difference between the Cathode and Anode layers 12A and 12C (e.g., 20 kV) is maintained, and the selective pixel actuation is implemented via controlling (or operating) voltage supply to the grid-like Gate electrode layer to thereby selectively apply a potential difference (e.g., about 5V) between the Gate electrode 12B and the selective Cathode electrode-element(s) Cᵢ. This may be carried while maintaining a certain illumination value of the cathode or while controllably varying the illumination. Considering the pixel-patterned Gate electrode layer 12B, the selective pixel actuation is carried out by selectively applying a potential difference between the selected Gate electrode-element and the corresponding (aligned therewith) Cathode electrode-element. Similarly, the illumination may be maintained or varied. As indicated above, the pixel array may be defined by “rows” and “columns” of different electrode layers, respectively, in which case the voltage supply is operated accordingly.

It should be understood that the Gate electrode is used for controlling an electric current between the Cathode and Anode electrodes. The closer the Gate layer to the Cathode layer, the lower voltage supply to the Gate can be used for controlling this electric current.

FIG. 1B schematically illustrates a display device 100 according to another embodiment of the invention. To facilitate understanding, the same reference numbers are used for identifying components that are common in all the examples of the invention. The device is configured generally similar to the device 10 of FIG. 1A, namely, includes an electrodes' arrangement 12 and an electrons extractor (illuminator) 14, and distinguishes from device 10 in that the illuminator 14 in device 100 is mounted externally to the electrodes' arrangement 12 and illuminates the Cathode layer 12A via at least partially transparent structure 25 formed by the Anode layer with the luminescent screen assembly 22 thereon.

It should be noted that making the structure 25 (Anode layer with luminescent screen thereon) light transparent (partially or completely transparent), irrespective of whether internal or external illumination for electrons' extraction is used, also allows for controlling the image brightness of the display device by means of external light. The external light is used in this case as a photon source for electron emission. Hence, when the background illumination is high, it will cause many electrons to be emitted from the Cathode, thereby increasing the brightness of a displayed image.

As indicated above, the illuminator assembly 14 includes one or more light emitting elements generating light of a wavelength range including that of the exciting illumination for the Cathode electrode used in the device. For example, the light emitting element(s) may be operable in the red part of the optical spectrum.

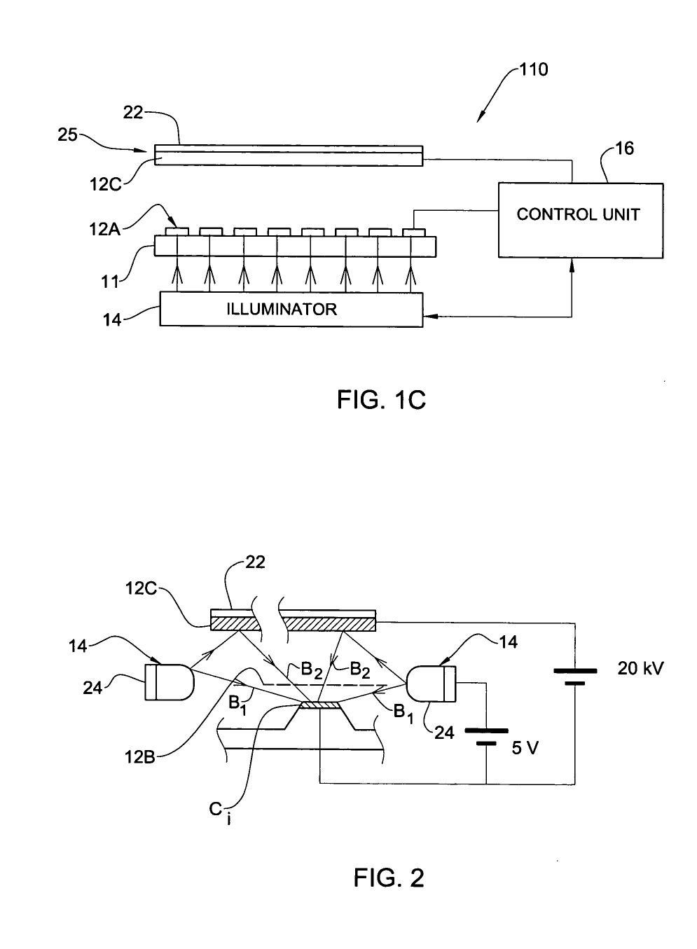

Turning back to FIG. 1A, the illuminator assembly 14 is configured so as to illuminate the inner surfaces of the Cathode and Anode layers 12A and 12C by which they face each other, or practically to illuminate the entire space within the cavity defined by the electrodes' arrangement. FIG. 2 more specifically illustrates the effect of this illumination. Here, the illuminator 14 includes at least two light units (light emitting elements or light guiding elements) 24 located at opposite sides of the electrodes' arrangement between the Cathode and Anode planes. As shown, the light unit 24 is oriented so as to directly illuminate both the Cathode and Anode layers 12A and 12C. Hence, the Cathode layer 12A is irradiated by both direct illumination B₁ and light reflections B₂ from the Anode layer. In the present example, the grid-like Gate electrode is shown, but it should be understood that the Gate electrode may be pixel-patterned, or may not be used at all. Considering the use of the Gate electrode 12B, when the device is put in operation, the control unit may operate the illuminator assembly 14 to provide certain illumination of the Cathode, operate the power supply unit to supply voltages to the Cathode and Anode layers to maintain a certain potential difference between them (e.g., about 20 kV), and selectively apply an operating voltage (potential difference), e.g., of about 5V, between the respective Cathode-electrode Cᵢ and the Gate electrode 12B, in accordance with an image to be displayed. It should, however, be noted that the selective pixel actuation may utilize both modifying the illumination and modifying the electric field between the Cathode and Anode electrodes (by modifying a potential difference between them or by affecting voltage supply to the Gate).

FIG. 1C shows a display device 110 according to yet another embodiment of the invention. The device 110 is generally similar to the above-described examples, but here the Cathode electrode layer 12A, as well as a substrate 11, is at least partially transparent with respect to the wavelength range of the exciting illumination, and the illuminator assembly 14 is configured so as to illuminate the Cathode surface opposite to that by which it faces the Anode, from below the substrate 11.

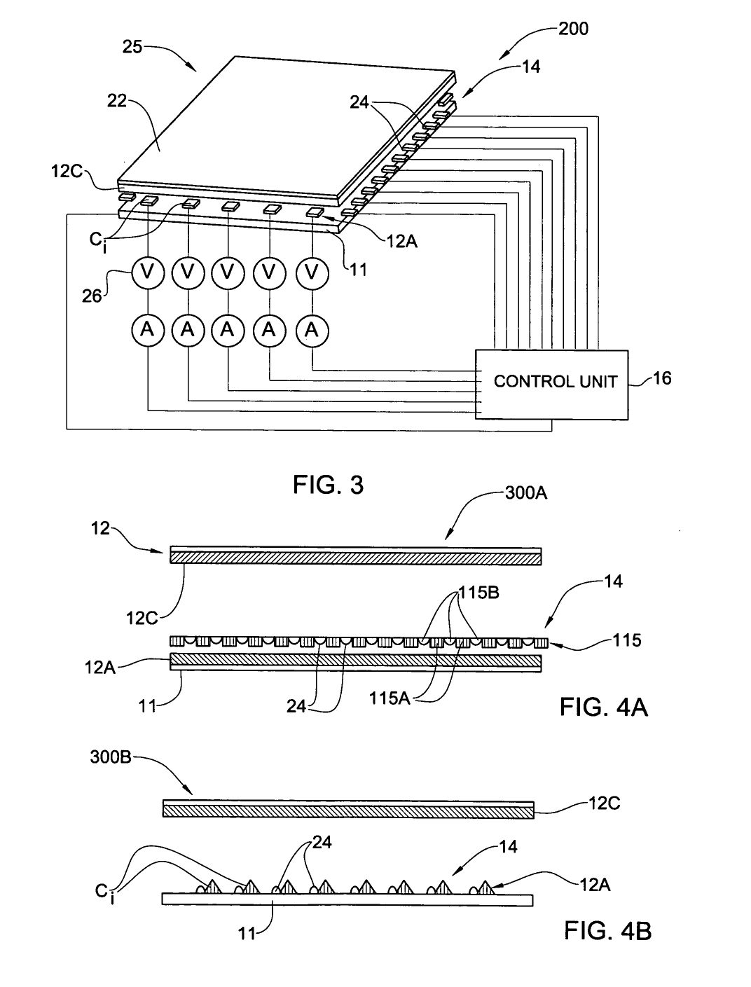

FIG. 3 exemplifies a specific but non limiting example of the implementation of a display device 200 of the present invention. The display device 200 includes an electrodes' arrangement 12 including a Cathode layer 12A in the form of an array of electrode-elements Cᵢ on top of a substrate 11; and an Anode layer 12C (which may a single- or multiple-electrode layer). The Cathode and Anode layers are spaced from each other by vacuum or gas-medium gap. In the present example, an illuminator assembly 14, which is configured to illuminate the Cathode layer (or Anode layer as well), is designed to define a frame surrounding the space between the Cathode and Anode layers (e.g., in a central plane between the Cathode and Anode layers). In the present example, this is implemented by using an array of light units 24 (light emitting elements (e.g., LEDs) or light guiding elements associated with the same or different light emitters) accommodated aside the Cathode and Anode layers within the space between them and arranged in a spaced-apart relationship as a frame surrounding the space between the Cathode and Anode layers. As indicated above, at least one of the electrode layers is patterned—Cathode layer in the present example. Each Cathode element Cᵢ is associated with its own voltage supply unit, generally at 26. Considering there is no Gate electrode in the electrodes' arrangement (as shown in the present example), when the display device is put in operation, the illuminator 14 may be operated to provide certain illumination of the Cathode (or controllably variable illumination), and the actuation of the selective image pixel(s) may be achieved by selectively applying a potential difference between the selected Cathode element(s) and the Anode layer, in accordance with an image to be displayed.

Thus, the device of the present invention utilizes an illuminator 14 as means for extracting electrons from the Cathode. It is important to note that due to the use of illumination of the Cathode layer, the device of the present invention is practically not limited by the dimensions of the Cathode electrode-element, and is operable with significantly lower operating voltages to achieve a required electrical current, than the field emitting based devices of the kind specified.

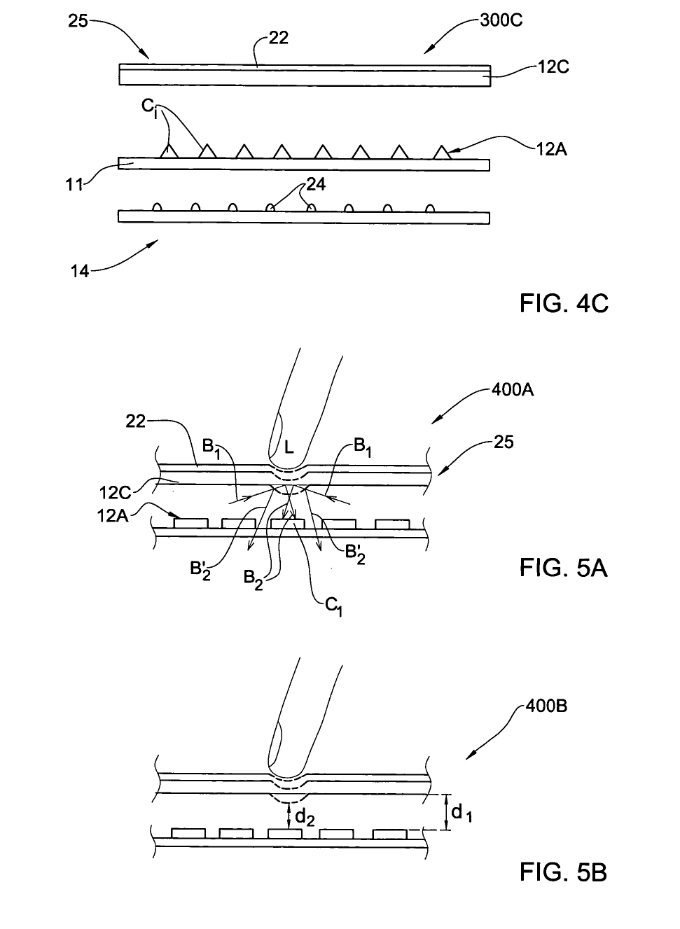

Reference is now made to FIGS. 4A-4C illustrating three specific but not limiting examples, respectively, of a display device according to another embodiment of the present invention. According to this embodiment, an electrons' extractor is used for controlling an electric current between the Cathode and Anode electrodes to implement selective pixel actuation. In other words, in this embodiment, the illuminator is configured to illuminate one or more selective regions of the Cathode electrode layer, rather than the entire Cathode layer as described above. The electrons' extractor thus functions as the so-called “floating gate”. To this end, in this embodiment, the illuminator assembly defines an array of light units (e.g., an array of light emitting elements, or an array of light guiding units associated with a common light emitter or an array of light emitters). The light units are accommodated such that each light unit illuminates a corresponding region of the Cathode (preferably, the light units are accommodated in a plane parallel to the Cathode-electrode layer). Considering for example an array of light emitting elements, each light emitting element may be separately addressed by a voltage supply unit (not shown here) to thereby modify its operational mode and selectively illuminate a corresponding region of the Cathode electrode to emit electrons therefrom. Alternatively, the light unit includes a light guiding unit, including for example a polarization rotator, that may be shiftable between its different operational modes to thereby selectively affect the illuminating light coming from a light emitter.

In the example, of FIG. 4A, a display device 300A includes an electrodes' arrangement 12 including Cathode and Anode layers 12A and 12C (which may or may not be patterned) arranged in a spaced-apart relationship one above the other and electrically supplied to be under a controllable potential difference between them. An electrons' extractor assembly (illuminator) 14 is constituted by an array of spaced-apart light units (light emitting elements, such as LEDs, or light guiding units) 24 accommodated so as to illuminate the spaced-apart regions, respectively, of the Cathode layer 12A. Actuation of a selective image pixel is achieved by shifting a selective one of the light units from its one operational mode to the other (e.g., shifting the selective light emitting element from an inoperative position into an operational position) to illuminate a selected region of the Cathode electrode layer to cause electron emission therefrom and thus affect an electric current between the illuminated Cathode electrode region and a corresponding Anode electrode-regions aligned with the illuminated Cathode region. It should be noted that the selective pixel actuation may additionally include the controllable variation of a potential difference between the Cathode and Anode.

As further shown in FIG. 4A, in order to prevent a change of light intensity actuating the selected pixel from affecting a change in an electric current of a locally adjacent pixel, the illuminator assembly 14 is equipped with an optical mask 115 located adjacent to the light units 24 in a manner to define light blocking regions within the spaces between the light units 24. As shown in the present example, the mask 115 presents an array of spaced-apart projections 115A spaced by grooves (recesses or holes) 115B. The light units 24 are located in these grooves 115A, respectively. Each two locally adjacent projections 115B thus serve as light blocking (screening) regions for light coming from the light unit 24 located in the space therebetween. It should be noted, although not specifically shown, that such an illuminator 14, formed by the optical mask 115 with the light units (e.g., light emitting elements) 24 mounted thereon, may be attached to the inner surface of the Anode electrode 12C (by which it faces the Cathode layer).

In the example of FIG. 4B, a display device 300B includes a Cathode electrode layer 12A, an Anode electrode layer 12C located above the Cathode layer 12A being spaced therefrom by a gap, and an electrons' extractor assembly (illuminator) 14 formed by an array of light units 24 (e.g., light emitting elements) associated with the Cathode electrode layer 12A. Here, in order to prevent a change of light intensity actuating the selected pixel from affecting a change in an electric current of a locally adjacent pixel, the Cathode electrode layer 12A is formed by an array of spaced-apart tip-like Cathode-elements Cᵢ projecting from a substrate 11 towards the Anode layer 12C, and each light unit 24 is located proximate the corresponding one of the Cathode-electrode tips Cᵢ.

FIG. 4C shows a display device 300C, which is generally similar to the above-described device 300B, namely, includes a Cathode electrode layer 12A, an Anode electrode layer 12C located above the Cathode layer 12A being spaced therefrom by a gap, and an electrons' extractor assembly (illuminator) 14 formed by an array of light units (e.g., light emitting elements) 24 arranged in a spaced-apart relationship in a plane parallel to the Cathode layer 12A. Here, however, the light units 24 are located below the Cathode layer. The Cathode layer 12A (which may be in the form of an array of Cathode elements or Cathode-electrode tips Cᵢ or may be a continuous material layer), as well as the Cathode carrying substrate 11, is made of a material at least partially transparent with respect to the exciting illumination.

The device of the present invention thus utilizes the photoelectric effect, according to which photons are used for ejecting electrons from a Cathode material (Cathode-electrode), provided the photon energy exceeds the work-function of the material from which the Cathode is made. As indicated above, the Cathode electrode may be made from Cs-coated metal or semiconductor. The Anode electrode may be made from a thin layer of Aluminum. It should be noted that the Cathode electrode can be made from a material with the work function higher than the energy of photons of undesired light, namely of light that may reach the Cathode from outside the display device, or from the luminescent screen structure especially in the case it is located on the inner surface of the Anode electrode layer. Comparing the use of the photoelectric effect (namely, electrons' emission as a result of illumination of the Cathode electrode) to a field emission effect, the photoelectric effect allows for effective operation of the device with more stable and higher-current operation (e.g., 5 μA per pixel). The photoelectric effect can be used for pixel identification (selective pixel actuation) as shown in the embodiment of FIGS. 4A-4C.

It should be noted that the technique of the present invention provides for making a display panel flat and flexible, of a simple construction and operation, as compared to those of the conventional devices of the kind specified, as well as provides the possibility of making the display panel foldable (e.g., rollable).

Illumination of the Cathode electrode can be used in the display device of the present invention to implement identification of a selected pixel of the display device as an interactive screen function, namely, touch screen function or remote pointing function. The following are some specific, but not limiting, examples of the implementation of the interactive screen function.

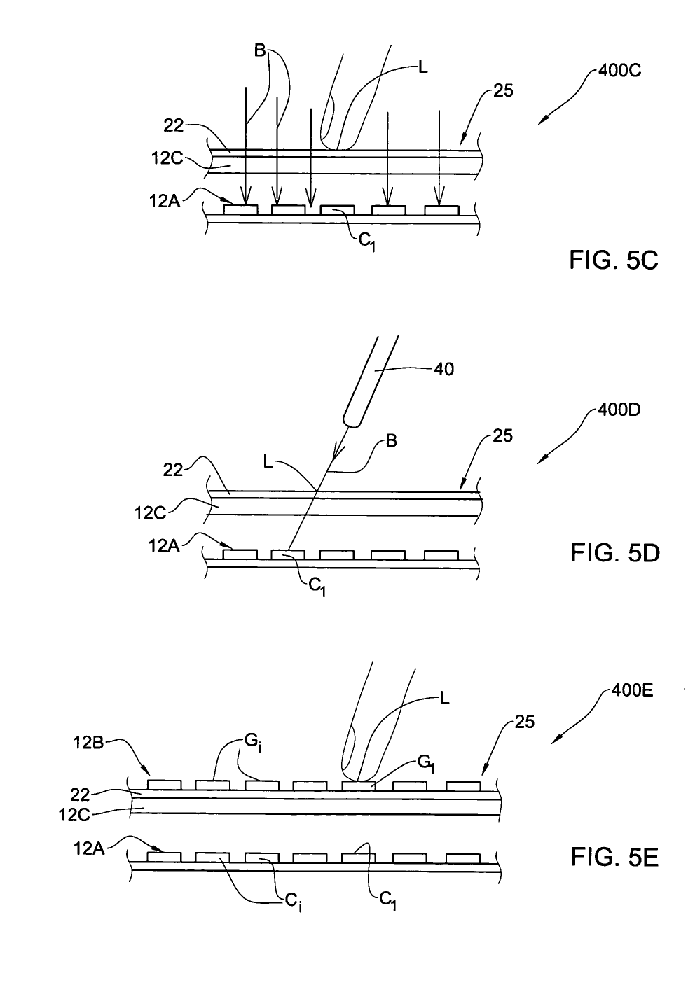

FIG. 5A shows a part of a display device 400A. The electrons' extractor assembly (not shown here) is oriented with respect to an electrodes' arrangement to provide illumination of a Cathode electrode 12A by light reflections from the inner surface of an Anode electrode 12C (e.g., in addition to direct illumination of the Cathode electrode). A structure 25 formed by the Anode electrode 12C with a luminescent coating (screen assembly) 22 thereon is sufficiently flexible so as to be easily deformable at a touched location L on the outer surface of this structure. Deformation of the Anode surface at the touched location causes a change in the light scattering effect, i.e., a change in the propagation of light, reflected from the Anode within the touched location, towards the Cathode. When in a flat (non-deformed) position of the location L, a light beam B₁ incident onto the Anode 12C within this location L (i.e., a corresponding location aligned with location L) is reflected towards the Cathode layer along a path B₂ and impinges onto the Cathode element C₁. As shown in the figure in dashed curves, when in the deformed position of the location L, the light beam B₁ reflected from the Anode layer propagates along another path B′₂ and impinges onto the Cathode layer outside the Cathode-element C₁. As a result, different amount of light reaches the respective Cathode region (i.e., that underneath the touched location), as compared to the other Cathode regions, and the touched location can thus be identified by measuring a change in the electric current created between this Cathode region and the Anode layer. It should be understood that the touched location may be aligned with several Cathode-elements (image pixels), and the single-pixel example, is shown here solely for the purposes of simplifying the illustration.

FIG. 5B exemplifies a display device 400B utilizing another implementation of the touch screen function. Here, the electrons' extractor assembly is operable to directly illuminate the Cathode electrode layer, and a structure formed by the Anode electrode layer 12C with the luminescent screen thereon is sufficiently flexible so as to be easily deformable at the touched location. Deformation of the Anode surface at a touched location L on the outer surface of this structure causes a local change in a distance between the Cathode and Anode layers from d₁ to d₂<d₁, and thus causes a change in the electric field between respective regions of the Cathode and Anode aligned with the touched location L. As a result, the local photoelectron current changes between the Cathode and the Anode at the location of the deformation of the Anode, as compared to that of other locations. Detection of this change in current allows for detecting the touched location.

The use of external light also allows for identifying a touched location. This is illustrated in FIG. 5C, showing (partially) a device 400C, which is generally similar to the above-described examples, but utilizes at least partially light transparent structure 25 formed by an Anode layer 12C with a luminescent screen assembly thereon. Due to the transparency of this structure, the Cathode layer is exposed to external light B coming through this structure. Touching a specific location L on the device results in local blocking of the external light propagation towards the Cathode region C₁ through the structure 25 within the location L. This causes a change in an electric current between the Anode layer within this touched location L and the respective Cathode electrode region C₁ aligned (vertically) with the touched location.

Yet another implementation of an interactive screen function consists of using the so-called “remote light triggering”. FIG. 5D shows a part of a display device 400D in which a structure 25, formed by an Anode layer 12C with a luminescent screen assembly 22, is at least partially light transparent to a wavelength range of a Remote Trigger 40 (a remote light source), thus enabling light B from the Remote Trigger 40 to propagate through this structure and reach the Cathode. Illumination of a certain location L of the Anode structure by the Remote Trigger 40 causes a local change in a photoemission current between a Cathode-element C₁ and the Anode layer within an area illuminated by the Remote Trigger. This local change in current can be measured, thus enabling detection of a location to which the Remote Trigger was aiming. This feature of the present invention can advantageously be used for example in a video game in which the player needs to shoot a character on the screen. The player is provided with a “gun” presenting the Remote Trigger. The Remote Trigger is a light emitting device operating in any desired wavelength to which the selected Cathode material is sensitive (i.e. the energy of the emitted photons is equal or higher than the work function of the Cathode).

FIG. 5E schematically illustrates yet another possible implementation of the touch-screen feature in a display device 400E according to the invention. The device 400E is constructed generally similar to the above-described devices, and also includes a Gate electrode layer 12B which is made from a transparent electrically conductive material and is located on top of a structure 25 (Anode layer 12C with a luminescent screen assembly 22 thereon). The Gate layer 12B (and/or the luminescent screen assembly 22) is patterned (similarly to the Cathode layer 12A) to thereby define an array of Gate electrodes, generally at Gᵢ. Touching the outer surface of the device (i.e., the surface of the Gate layer) within a specific location L results in modifying an electric field applied via the respective Gate element G₁, which affects a change in the electric current between the Anode electrode 12C and the respective Cathode element C₁ aligned with the Gate element G₁. This change in the electric current allows for identifying the touched location L.

It should be understood, although not specifically shown, that the display device of the present invention may be configured for displaying colored images. To this end, the device is configured to define primary colors (RGB) sub-pixels. This may be achieved by appropriately patterning the luminescent screen assembly to include different luminescent coatings.

As indicated above, the gap between the Cathode and Anode electrodes may be a gas-medium gap (e.g., air, inert gas) and not a vacuum gap. The length of the gas-medium gap substantially does not exceed a mean free path of electrons in the gas environment. For example, the gap length is in a range from a few tens of nanometers (e.g., 50 nm) to a few hundreds of nanometers (e.g., 800 nm). Considering the device configuration with the gas-medium gap between the Cathode and Anode and no photoelectric effect (e.g., no illuminator 14 in FIG. 1A), an electric current between the Cathode and Anode may be controlled by varying a potential difference between them and/or by affecting a voltage supply to a gate electrode. Turning back to FIGS. 5B and 5E, it should be understood that the same principles are applicable to such a gas-medium based device with no photoelectric effect for identifying the touched location.

Those skilled in the art will readily appreciate that various modifications and changes can be applied to the embodiments of the invention as hereinbefore described without departing from its scope defined in and by the appended claims.

1. A display device comprising:
an electrodes' arrangement including a Cathode electrode layer having at least one Cathode electrode and an Anode electrode layer having at least one Anode electrode, the Cathode and Anode electrode layers being accommodated in a spaced-apart relationship with a gap between them, the Anode electrode layer carrying a luminescent screen assembly on its surface, the electrodes arrangement being operable to create a desired electrical field between the electrodes;
an electrons' extractor for extracting electrons from at least a selected region of the Cathode electrode layer by illuminating said at least selected region of the Cathode electrode layer with exciting illumination of a predetermined wavelength range to cause the electron emission from the illuminated Cathode region.

2. The device of claim 1, wherein a material of the Cathode electrode layer and the predetermined wavelength range are such that work function of the Cathode layer material is higher than energy of photons outside said predetermined wavelength range.

3. The device of claim 1, wherein said predetermined wavelength range includes the red part of optical spectrum.

4. The device of claim 1, wherein said electrons' extractor comprises at least one light unit configured and oriented with respect to the electrodes' arrangement so as to illuminate at least the Cathode electrode.

5. The device of claim 1, wherein said electrons' extractor comprises at least one light unit configured and oriented with respect to the electrodes' arrangement so as to illuminate the entire surface of the Cathode electrode layer by which it faces the Anode electrode layer.

6. The device of claim 1, wherein said electrons' extractor comprises at least one light unit configured and oriented with respect to the electrodes' arrangement so as to illuminate the entire inner surfaces of the Cathode and Anode electrode layers by which they face each other.

7. The device of claim 1, wherein said electrons' extractor comprises at least one light unit accommodated outside the electrodes' arrangement and oriented so as to illuminate the inner surface of the Cathode electrode layer, by which it faces the Anode electrode layer, through the Cathode layer, the Cathode layer being at least partially transparent with respect to said predetermined wavelength range.

8. The device of claim 7, wherein the Cathode layer is located on a substrate made of a material at least partially transparent with respect to said predetermined wavelength range.

9. The device of claim 5, wherein said at least one light unit is configured as a frame-like structure surrounding a space between the Cathode and Anode layers.

10. The device of claim 6, wherein said at least one light unit is configured as a frame-like structure surrounding a space between the Cathode and Anode layers.

11. The device of claim 5, wherein said electrons' extractor comprises an array of light units arranged in a spaced-apart relationship to form a frame-like structure surrounding a space between the Cathode and Anode layers.

12. The device of claim 6, wherein said electrons' extractor comprises an array of light units arranged in a spaced-apart relationship to form a frame-like structure surrounding a space between the Cathode and Anode layers.

13. The device of claim 1, wherein the gap between the Cathode and Anode layers is evacuated.

14. The device of claim 1, wherein the Cathode and Anode layers are spaced from each other by the gas-medium gap.

15. The device of claim 1, wherein the Cathode and Anode layers are spaced from each other by the air gap.

16. The device of claim 14, wherein a gas pressure in the gap between the Cathode and Anode layers is selected so as to provide a mean free path of electrons accelerating from the Cathode to the Anode larger than a length of the gap between the Cathode and the Anode layers.

17. The device of claim 1, wherein at least one of the Cathode and Anode electrode layers is formed by an array of spaced-apart electrode-elements, defining an image pixel array of the display device.

18. The device of claim 1, wherein the Cathode electrode layer is formed by an array of spaced-apart Cathode-elements defining an image pixel array of the display device.

19. The device of claim 1, wherein the Cathode electrode layer is patterned to define a first array of elongated spaced-apart parallel Cathode-elements extending along a first axis, and the Anode electrode layer is patterned to define a second array of spaced-apart parallel Anode-elements extending along a second axis perpendicular to the first axis, the first and second arrays defining together a two-dimensional image pixel array of the display device.

20. The device of claim 17, comprising a control unit operating the electrodes' arrangement to selectively effect a change in a potential difference between the selective one of the electrode-elements of said at least one of the Cathode and Anode layers and the other of said electrode layers.

21. The device of claim 17, comprising a control unit operating the electrodes' arrangement to selectively effect a change in a potential difference between the selected one of the Cathode electrode-elements and a corresponding one of the Anode electrode-elements aligned with said selected Cathode electrode-element.

22. The device of claim 20 or 21, wherein the control unit operates the electrons' extractor to provide a certain intensity of said illumination of the surface of the Cathode electrode layer by which it faces the Anode layer.

23. The device of claim 20 or 21, wherein the control unit operates the electrons' extractor to provide the controllable variable illumination of the surface of the Cathode electrode layer by which it faces the Anode layer.

24. The device of claim 1, wherein the electrodes' arrangement comprises a Gate electrode layer accommodated between the Cathode and Anode electrode layers.

25. The device of claim 24, wherein at least one of the Cathode and Anode electrode layers is formed by an array of spaced-apart electrode-elements, defining an image pixel array of the display device.

26. The device of claim 25, wherein the Gate electrode layer is in the form of a grid allowing a material propagation therethrough.

27. The device of claim 26, comprising a control unit operating the electrodes' arrangement to maintain a certain potential difference between the Cathode electrode layer and the Anode electrode layer, and to selectively apply a certain potential difference between the Gate electrode layer and at least one selected electrode-element thereby effecting a change in an electric current between said at least one electrode-element and the other one of the Cathode and Anode layers, as compared to that of the other electrode-elements, thus effecting actuation of at least one selected image pixel of the display device.

28. The device of claim 27, wherein the control unit operates the electrons' extractor to provide a certain value of said illumination of the surface of the Cathode electrode layer by which it faces the Anode layer.

29. The device of claim 27, wherein the control unit operates the electrons' extractor to provide the controllably variable illumination of the surface of the Cathode electrode layer by which it faces the Anode layer.

30. The device of claim 25, wherein the Gate electrode layer is in the form of an array of Gate electrode-elements arranged in a spaced-apart relationship in accordance with a pixel array of the device.

31. The device of claim 30, comprising a control unit operating the electrodes' arrangement to maintain a certain potential difference between the Cathode and Anode electrode layers, and to selectively apply a certain potential difference between a selected one of the Gate electrode-elements and a corresponding one of the Cathode electrode-elements thereby effecting a change in an electric current between the selected electrode-elements, as compared to that of the other electrode-elements and thus effecting actuation of at least one selected image pixel of the display device.

32. The device of claim 31, wherein the control unit operates the electrons' extractor to provide a certain value of said illumination of the surface of the Cathode electrode layer by which it faces the Anode layer.

33. The device of claim 31, wherein the control unit operates the electrons' extractor to provide the controllably variable illumination of the surface of the Cathode electrode layer by which it faces the Anode layer.

34. The device of claim 1, comprising a control unit operating the electrons' extractor to illuminate the at least one selected region of the Cathode electrode layer thereby affecting an electric current between the Anode electrode layer and said at least one selected region of the Cathode layer, thus effecting actuation of at least one selected image pixel of the display device.

35. The device of claim 34, wherein the control unit operates the electrodes' arrangement to maintain a certain potential difference between the Cathode and Anode electrode layers.

36. The device of claim 34, wherein the control unit operates the electrodes' arrangement to controllably vary a potential difference between the Cathode and Anode electrode layers.

37. The device of claim 1, wherein said electrons' extractor is in the form of an array of light units defining an image pixel array, said array of light units being arranged in a spaced-apart relationship such that each of the light units is associated with a corresponding region of the Cathode electrode layer.

38. The device of claim 37, wherein each of said light units is addressed by power supply, operation of at least one selected light units to illuminate the at least one corresponding region of the Cathode electrode layer resulting is actuation of the at least one selected image pixel.

39. The device of claim 37, wherein each of said light units is operable to be shiftable between its different operational modes to thereby vary intensity of light produced by the light unit, thereby allowing actuation of the at least one selected image pixel.

40. The device of claim 37, wherein the electrons' extractor is configured to prevent a change of the illumination intensity actuating the selected pixel from affecting a change in an electric current of a locally adjacent pixel.

41. The device of claim 40, wherein the electrons extractor comprises an optical mask located adjacent to the array of light units.

42. The device of claim 41, wherein the optical mask is in the form of an array of spaced-apart light blocking regions, said light units being located within the spaces, respectively, between the light blocking regions

43. The device of claim 41, wherein the optical mask is an optically insulating structure patterned to define an array of projections spaced-apart by grooves, said light units being located in said grooves so as to be spaced-apart from each other by said projections.

44. The device of claim 37, wherein the Cathode electrode layer is formed by an array of tip-like Cathode-elements projecting towards the Anode electrode layer, each of said light units being located proximate to the corresponding one of said tip-like Cathode-element, operating one of the light units resulting in maximally affecting an electric current between the corresponding tip-like Cathode-element and the Anode electrode, as compared to that of Cathode layer regions adjacent to said tip-like element.

45. The device of claim 37, wherein the array of light units is accommodated outside the electrode's arrangement at the side of the Cathode electrode layer, the Cathode layer being made of a material at least partially transparent with respect to said predetermined wavelength range.

46. The device of claim 45, wherein the Cathode layer is carried on a substrate made of a material at least partially transparent with respect to said predetermined wavelength range.

47. The device of claim 1, wherein a structure formed by the Anode electrode layer with the luminescent screen assembly thereon is at least partially transparent.

48. The device of claim 47, wherein the luminescent screen structure is carried by the inner surface of the Anode electrode layer by which it faces the Cathode electrode layer.

49. The device of claim 47, wherein said electrons' extractor utilizes external radiation for illuminating the Cathode electrode layer through the Anode electrode layer.

50. The device of claim 1, configured and operable to enable identification of an externally pointed location on the outer surface of a structure formed by the Anode layer with the luminescent screen thereon.

51. The device of claim 50, wherein said structure formed by the Anode layer with the luminescent screen thereon is configured to be sufficiently flexible such that pointing the selected location by touching the outer surface of said structure within the selected location causes a local deformation of the structure at the touched location, thereby causing a change in an electric current between the Cathode and Anode layer regions aligned with the touched location, as compared to all the other regions, and enabling identification of the touched location by detecting this change.

52. The device of claim 50, wherein
said electrons' extractor comprises at least one light unit accommodated to illuminate the inner surface of the Cathode electrode layer by which it faces the Anode layer by light reflections from the Anode layer,
said structure formed by the Anode layer with the luminescent screen thereon is configured to be sufficiently flexible such that pointing the selected location by touching the outer surface of said structure within the selected location causes a local deformation of the structure at the touched location, said local deformation causing a local change in a light scattering effect, thereby causing a local change in the electric current between the Cathode and Anode layers regions aligned with the touched location.

53. The device of claim 50, wherein said structure formed by the Anode layer with the luminescent screen assembly thereon is configured to be sufficiently flexible such that pointing the selected location by touching the outer surface of said structure within the selected location causes a local deformation of the structure at the touched location, said local deformation causing a local change in a distance between the Anode and the Cathode layers thus causing a local change in an electric field resulting in a local change in the electric current between the Cathode and Anode layers regions aligned with the touched location.

54. The device of claim 47, configured and operable to enable identification of an externally pointed location of the display device, touching an external surface of the Anode electrode layer within said location causing a local change in the illuminating light intensity at a region of the Cathode electrode layer aligned with the touched location due to a local change in external light propagating to the Cathode through the Anode at the touched location, thereby enabling identification of the touched location as a change in an electric current between the Cathode and Anode layer regions underneath the touched location.

55. The device of claim 47, operable to enable identification of a remotely pointed location on an outer surface of a structure formed by the Anode electrode layer with the luminescent screen thereon, light coming from outside of the device through the remotely pointed location towards a corresponding region of the Cathode layer causing a local change in an electric current between the Anode layer and the selected region of the Cathode layer.

56. A display device comprising:
an electrodes' arrangement including a Cathode electrode layer having at least one Cathode electrode and an Anode electrode layer having at least one Anode electrode, the Cathode and Anode electrode layers being accommodated in a spaced-apart relationship with a gap between them, and a Gate electrode layer in the form of a grid located between the Cathode and Anode layers, the Anode layer carrying a luminescent screen structure on its surface, at least one of the Cathode and Anode electrode layers being formed by an array of spaced-apart electrode-elements defining an image pixel array of the display device,
an electrons' extractor configured and operable to produce exciting radiation to illuminate at least a selected region of the Cathode electrode layer to extract electrons from the illuminated Cathode electrode;
a control unit for operating the electrodes' arrangement by supplying voltages to the electrodes, and operating the electrons' extractor to illuminate the Cathode electrode;
the device being operable to actuate a selective image pixel by carrying out at least one of the following: varying the voltage supply to the Gate, and modifying the illumination reaching the Cathode layer.

57. A display device comprising:
an electrodes' arrangement including a Cathode electrode layer having at least one Cathode electrode and an Anode electrode layer having at least one Anode electrode, the Cathode and Anode layers being accommodated in a spaced-apart relationship with a gap between them, the Anode layer carrying a luminescent screen assembly on its surface, a structure formed by the Anode layer with the luminescent screen assembly thereon being at least partially optically transparent; and
an electrons' extractor configured and operable to produce exciting radiation to extract electrons from the Cathode electrode by illuminating at least a selective region of the Cathode electrode layer by the exciting radiation propagating to the Cathode through the Anode electrode layer.

58. A display device comprising:
an electrodes' arrangement including a Cathode electrode layer having at least one Cathode electrode and an Anode electrode layer having at least one Anode electrode, the Cathode and Anode layers being spaced by a gap, the Anode layer carrying a luminescent screen assembly on its surface;
an electrons' extractor operable to produce exciting radiation to extract electrons from the Cathode, the electrons' extractor comprising an array of light units arranged in accordance with an image pixel array, the light units being accommodated such that each of the light units illuminates a corresponding region of the Cathode electrode layer and thus extracts electrons therefrom.

59. A display device comprising:
an electrodes' arrangement including a Cathode electrode layer having at least one Cathode electrode and an Anode electrode layer having at least one Anode electrode, the Cathode and Anode layers being accommodated in a spaced-apart relationship with a gap between them, the Anode layer carrying a luminescent screen assembly on its surface, the Cathode electrode layer being made of a material at least partially transparent with respect to a spectral range of exciting radiation;
an electrons' extractor configured to produce the exciting radiation to extract electrons from the Cathode, the electrons' extractor comprising an array of light units arranged in a spaced-apart relationship in accordance with an image pixel array, the light units being accommodated outside the electrodes' arrangement, each of the light units being separately operated to illuminate a corresponding region of the inner surface of the Cathode electrode layer through the Cathode layer to thereby extract electrons from the illuminated Cathode region towards the Anode layer.

60. A display device configured to define an array of image pixels, the device comprising an electrodes' arrangement, and an illuminator assembly configured and operable to produce exciting illumination to extract electrons from a Cathode electrode.

61. A display device comprising an electron emission device comprising an electrodes' arrangement including at least one Cathode electrode and at least one Anode electrode, the Cathode and Anode electrodes being arranged in a spaced-apart relationship; the electron emission device being configured to expose said at least one Cathode electrode to exciting illumination to thereby cause electrons' emission from said Cathode electrode.

62. A display device comprising an electron emission device comprising an electrodes' arrangement including at least one Cathode electrode, at least one Anode electrode, and at least one Gate electrode, the electrodes being arranged in a spaced-apart relationship; the electron emission device being configured to expose said at least one Cathode electrode to exciting illumination to thereby cause electrons' emission from said Cathode electrode.

63. A display device configured to define an array of image pixels, the device comprising an electrodes' arrangement, and an illuminator assembly producing exciting radiation to extract electrons from a Cathode electrode, the illuminator assembly being configured and operable to illuminate a surface of the Cathode electrode, by which it faces an Anode electrode, through the Cathode electrode made of a material at least partially transparent with respect to the exciting illumination.

64. A method for operating a display device which includes a Cathode electrode layer and an Anode electrode layer, the method comprising illuminating at least a selected region of the Cathode electrode layer with exciting radiation to extract electrons from the at least one illuminated Cathode region, thereby affecting an electric current between said at least one selected region of the Cathode electrode and an Anode electrode layer.

65. The method of claim 64, comprising selectively effecting a change in an electric field between two selected regions of the Cathode electrode layer and the Anode electrode layer, respectively, as compared to other regions of the Cathode and Anode layers, to thereby actuate a selective pixel of the display device.

66. The device of claim 65, comprising maintaining a certain value of the exciting illumination.

67. The device of claim 65, comprising controllably modifying the illumination.

68. The device of claim 65, wherein said change in the electric field is affected as a changed in a potential difference between said two selected regions of the Cathode electrode layer and the Anode electrode layer.

69. The device of claim 65, wherein said change in the electric field is affected as a changed in a voltage supply to a Gate electrode.

70. The method of claim 64, comprising selectively illuminating at least one region of the Cathode layer to extract electrons therefrom, thereby effecting a change in an electric current between said at least one Cathode region and the Anode layer, as compared to the other Cathode regions, thereby actuating at least one selected pixel of the display device.

71. The method of claim 70, comprising controllably varying an electric field between said at least one Cathode region and the Anode layer.

72. The method of claim 70, comprising maintaining a certain value of an electric field between said at least one Cathode region and the Anode layer.

73. The method of claim 71, wherein the controllable variation of the electric field comprises controllably varying a potential difference between said at least one Cathode region and the Anode layer.

74. The method of claim 71, the controllable variation of the electric field comprises controllably varying a voltage supply to a Gate electrode.

75. A display device comprising an electrodes' arrangement including a Cathode electrode layer and an Anode electrode layer which are accommodated in spaced-apart parallel planes with a gas-medium gap between them of a length substantially not exceeding a mean free path of electrons in said gas medium, the Anode layer carrying a luminescent screen assembly on its surface.

76. The device of claim 75, wherein the length of the gap between the Cathode and Anode electrodes substantially does not exceed 800 nm.

77. The device of claim 75, wherein the length of the gap between the Cathode and Anode electrodes is of about a few tens of nanometers.

78. The device of claim 75, wherein the length of the gap between the Cathode and Anode electrodes is from a few tens of nanometers up to a few hundreds of nanometers.
